(19) United States
(12) Patent Application Publication
(10) Pub. No.: US 2007/0022660 A1
(43) Pub. Date: Feb. 1, 2007

(54) Irrigation unit

(76) Inventors: Roelof Adriaan Buitendag, Bloemfontein (ZA); Philippus Swart, Bloemfontein (ZA)

Correspondence Address: Jennifer P. Yancy;Jones, Tullar & Cooper, P.O. Box 2266 Eads Station, Arlington, VA, 22202, US

(21) Appl. No.: 10/568,074

(22) PCT Filed: Aug. 13, 2004
(86) PCT No.: PCT/ZA04/00098

§ 371 Date: Feb. 13, 2006

(30) Foreign Application Priority Data
Aug. 14, 2003 (ZA) 2003/6253

(51) Int. Cl. A01G 9/02

(52) U.S. Cl. 47/81

(57) ABSTRACT

The invention provides an irrigation unit (10) for plants (76) which can either be used alone or in combination with a separate plant container (190) which irrigation unit includes a body (12) which has an upper side (14), a lower side (16), a base (18) on the lower side, an outer wall (20) which extends upwardly from the base and an inner wall (22) which is engaged with and spaced from the outer wall, a cavity (26) formed by the body, a reservoir (28) defined between the inner and outer walls which has an inlet (30) thereto and an outlet (32) therefrom into the cavity, an open ended fluid passage (40) which has a first upper end (42) which terminates in the reservoir and a second lower end (44) which terminates in the cavity, an overflow formation (56) which extends from the body and which is in communication with the cavity and a support platform (58) in the cavity.

### BACKGROUND OF THE INVENTION

This invention relates to an irrigation unit and container and more specifically a plant irrigation unit and container which provide continuous irrigation to plants.

A plant container fitted with an irrigation unit which has a water tank is known. The tank is provided with a water outlet to allow water flow from the tank into the container. An air conduit which has a lower end situated in the container and an upper end which terminates in the tank is provided so that water flow from the tank through the outlet is only allowed when the water level inside the container is below the level of the lower end. When the water level in the container reaches the level of the lower end a vacuum is formed within the tank and water flow from the tank is restricted.

A problem associated with known self irrigation containers is that water entering the container from above as a result of normal watering or rain often results in the over watering of the plants in the container and in extreme cases the plants may even drown. It is therefore not advisable to use self irrigation containers outdoors.

Another problem is that if the vacuum formed in the tank is for whatever reason compromised the plants in the container are flooded which results in over watering and possible damage to the plants.

Additionally it is difficult to ascertain the water level in the tank which might result in the late refill of the tank and the under watering of the plants.

### SUMMARY OF THE INVENTION

This invention aims to provide an alternative irrigation unit and container which might alleviate some of the aforementioned problems.

The invention provides an irrigation unit which includes a body which has an upper side, a lower side, a base on the lower side, an outer wall which extends upwardly from the base and an inner wall which is engaged with and spaced from the outer wall, a cavity formed by the body, a reservoir defined between the inner and outer walls which has an inlet thereto and an outlet therefrom into the cavity, an open ended fluid passage which has a first upper end which terminates in the reservoir and a second lower end which terminates in the cavity and an over flow formation which extends from the body and which is in communication with the cavity.

The body may be of any appropriate shape in plan and is preferably square or circular shaped in plan. The body may include a plant container which may be integrally formed with the body.

Preferably the outer wall is in the form of a continuous wall which surrounds the base. The inner wall may extend between the outer wall and the base and is preferably sealingly attached to both the outer wall and the base.

The cavity may be open ended towards the upper side and may be U-shaped in cross-section.

The inlet may include a plugged opening in the body. Alternatively the inlet may include an elongate liquid conduit which extends from an upper entrance to a lower exit into the reservoir. The upper entrance may be funnel shaped.

The outlet may include a valve means.

The overflow formation may be engaged with the base and is preferably in the form of an upstanding, open ended, tubular member which extends through the body and from the base into the cavity. Alternatively the overflow formation includes a spillway on the outer wall.

The overflow formation may include an overflow entrance which is spaced from the base and the outlet and the lower end are preferably located between the overflow entrance and the base.

The irrigation unit may include a support formation in the cavity. The support formation may divide the cavity into a lower section and an upper section. The outlet and the second lower end may be in direct communication with the lower section and the overflow formation may be in direct communication with the upper section.

The support formation may include a platform and a plurality of spacers engaged with the platform in order to space the platform from the base. Preferably the platform includes a plurality of apertures there through and an enlarged hole where through the overflow formation extends.

In one form of the invention the support formation includes a wall formation extending from the platform to define a receptacle wherein potting and plant material can be placed.

The support formation is preferably removably insertable into the cavity.

The irrigation unit may include a draining formation in the outer wall which is in communication with the reservoir.

The irrigation unit may include a liquid level indicator. The indicator may be located on the outer wall and may include a tubular member which has an elongate window, indicia on an interior of the tubular member and a float located inside the tubular member which is movable relatively to the tubular member. Alternatively the indicator may, at least partially be located in the reservoir.

The invention further provides a plant container which includes a housing and an irrigation unit of the aforementioned kind engaged with the housing. The irrigation unit may be integrally formed with the housing or may be removable therefrom.

The invention also extends to a support formation for use in an irrigation unit of the aforementioned kind which includes a platform which has a plurality of apertures and an enlarged hole there through and a wall formation which extends from and surrounds the platform.

Preferably the enlarged hole is located at a centre of the platform.

The support formation may include a plurality of spacers engaged with the platform.

The invention further extends to a method of growing a plant in a plant container of the aforementioned kind.

The method may include the step of least partially filling the reservoir with a liquid such as water.

### BRIEF DESCRIPTION OF THE DRAWINGS

The invention is further described by way of examples with reference to the accompanying drawings in which:

FIG. 1 is a cross-sectional side view of an irrigation unit according to the invention;

FIG. 2 is a plan view of the unit of FIG. 1;

FIG. 3 is a side view of the unit of FIG. 1;

FIG. 4 is a cross-sectional side view of a support tray used in the unit of FIG. 1;

FIG. 5 is a cross-sectional side view of a receptacle which could be used as an alternative to the support tray shown in FIG. 4, in the unit of FIG. 1;

FIG. 6 is a cross-sectional side view of an irrigation unit according to a different form of the invention;

FIG. 7 is an enlarged cross-sectional side view of an inner wall of an irrigation unit according to another form of the invention; and

FIG. 8 is a cross-sectional side view of an irrigation unit according to yet another aspect of the invention in a plant container.

### DESCRIPTION OF PREFERRED EMBODIMENTS

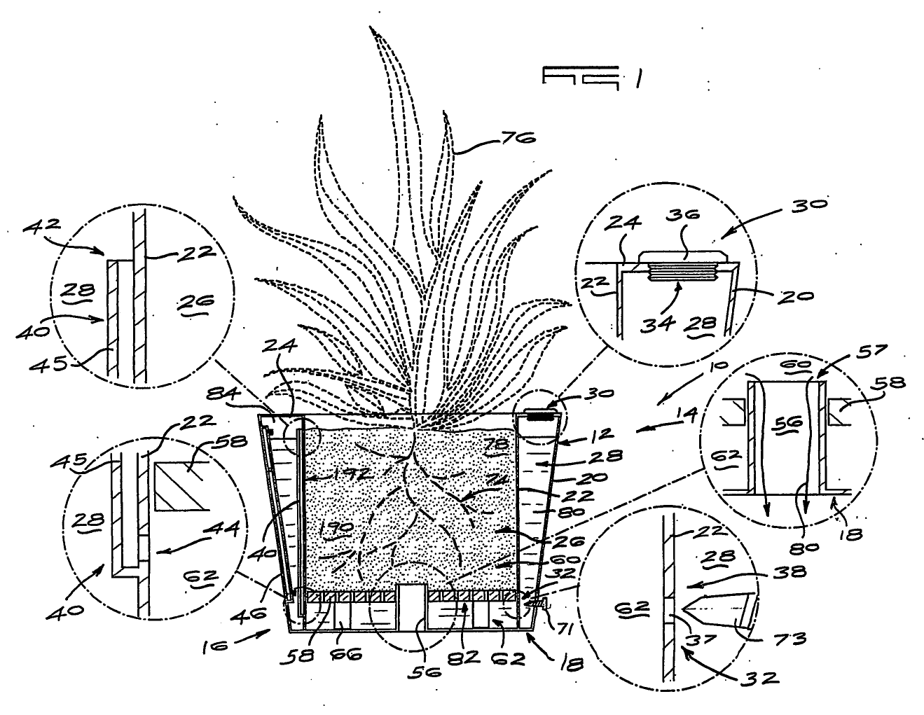

FIGS. 1, 2 and 3 illustrate an irrigation unit 10 with a body 12 which has an upper side 14, a lower side 16, a base 18 located at the lower side 16, a circular outer wall 20 which extends from and surrounds the base 18 and a circular inner wall 22 which is spaced from the outer wall 20 and attached to the base 18 and the outer wall 20. The inner wall 22 has a top section 24 which is engaged with the outer wall 20. Although the inner wall 22 can be sealingly attached to only the outer wall 20, the inner wall 22 in this example extends between the outer wall 20 and the base 18 and is sealingly attached to both the outer wall 20 and the base 18.

An open ended U-shaped cavity 26 is formed by the body 12 between the base 18 and the inner wall 22 and a water reservoir 28 is defined between the inner and outer walls 20, 22. As is evident from FIG. 1 the reservoir 28 extends around the cavity 26.

The reservoir 28 has an inlet 30 thereto and an outlet 32 there from into the cavity 26. The inlet 30 consists of an opening 34 in the top section 24. The opening 34 is plugged by a threaded plug member 36. The outlet 32 consists of an aperture 37 at a lower portion 38 of the inner wall 22.

An open ended fluid passage 40 extends from a first upper end 42 which terminates at the upper sides 14 in the reservoir 28 to a second lower end 44 which terminates at the lower side 16 in the cavity 26. The fluid passage 40 is in the form a tube 45 which extends downwards within the water reservoir 28 between the first upper end 42 and the second lower end 44.

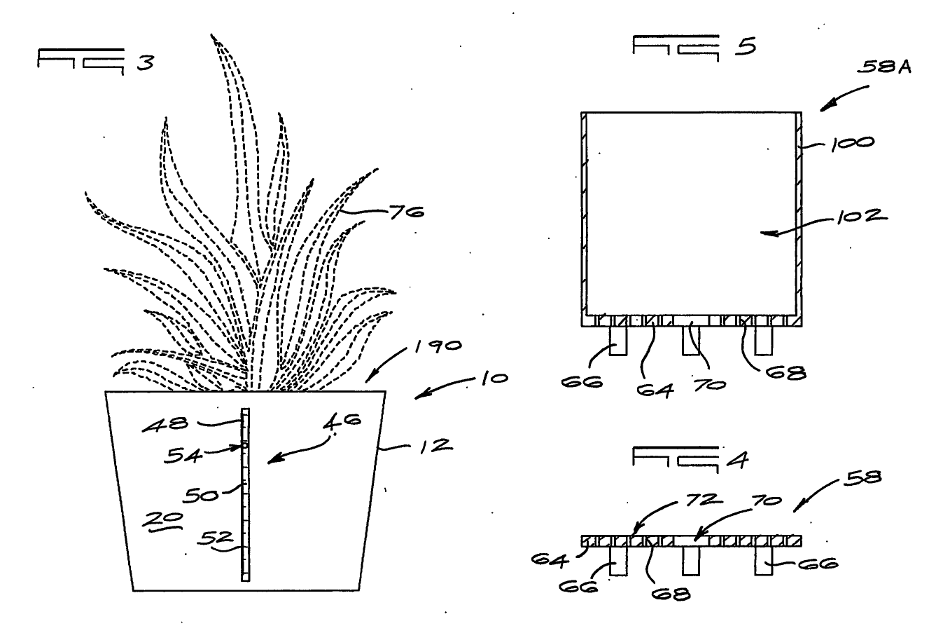

A fluid level indicator 46 is attached to the outer wall 20. The indicator 46 consists of a open ended, elongate tubular member 48 which has an elongate transparent window 50 (see FIG. 3), indicia 52 in the form of calibrations on an interior of the tubular member 48 and a float 54 which is located inside the tubular member 48 and which is movable relatively to the tubular member 48.

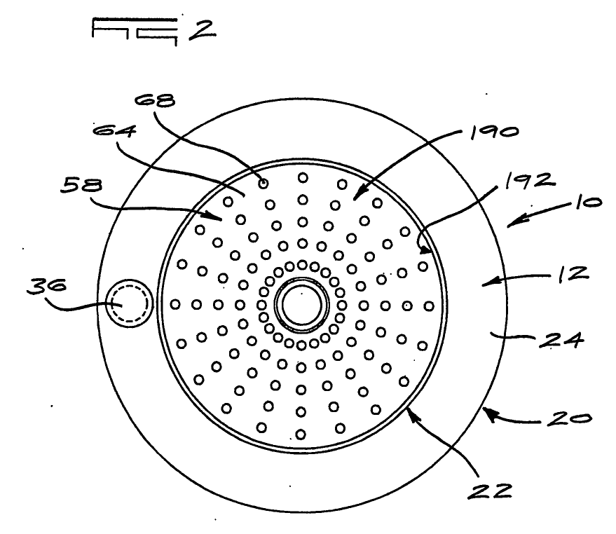

An open ended tubular overflow formation 56 is attached to and extends from the base 18 into the cavity 26 and through the body 12. The overflow 56 has an overflow entrance 57 which is spaced from the base 18 and which acts as a spillway. As is evident from FIG. 2 the overflow 56 is located at the centre of the circular base 18.

A removable support tray 58 is located inside the cavity 26 and divides the cavity 26 into an upper section 60 and a lower section 62. As is shown in FIG. 4 the support tray 58 has a platform 64 and a plurality of spacers 66 engaged with the platform 64 to space the platform 64 from the base 18. The platform 64 has a plurality of apertures 68 there through as well as an enlarged central hole 70 where through the upstanding overflow 56 extends. As can be seen in FIG. 2 the platform 64 also has a circular outline and covers the area of the base 18 between the inner wall 22 and the overflow 56.

Importantly the outlet 32 and the second lower end 44 are in direct communication with the second section 62 and are located between the base 18 and the overflow entrance 57. It is also important to note that the overflow 56 is in direct communication with, and the overflow entrance 57 is located in, the first section 60.

A drainage plug 71 is attached to the outer wall 20 and is in communication with the reservoir 28. The drainage plug 71 is threaded and can be threaded into out of the reservoir 28. The plug 71 has a valve seal 73 which extends into the reservoir 28 and which is sealingly engageable with the aperture 37 of the outlet 32.

The body 12 is made from an appropriate plastics material and can either be blow or rotationally moulded or assembled from separate injection moulded components. For example the base 18, outer wall 14 and overflow 56 can be injection moulded in one step and the inner wall 22 can be injection moulded in a separate step. Thereafter the indicator 46 and the drainage plug 71 are attached to the outer wall 20 and the fluid passage 40 and plug member 36 are attached to the inner wall 22. Thereafter the base 18 and outer wall 22, and the inner wall 22 are either clipped, glued or welded to one another in a known manner in order to form the sealed reservoir 28.

The support tray 58 is formed separately from the body 12 and is also made from an appropriate plastics material. An upper surface 72 of the support tray 58 is treated with an appropriate chemical such as for example trifluralin which is sold under the trade name BIOGUARD ROOT CONTROL FABRIC™ to repel plant roots 74 of plants 76 planted in the unit 10.

In use potting soil 78 is inserted into the upper section 60 on top of the platform 64 and the plants 76 are planted in the potting soil 78 in a known manner. Water 80 or any appropriate liquid mixture is poured into the reservoir 28 through the opening 34. When the float 54 reaches the upper side 14 it is an indication that the reservoir 28 is full and the opening 34 is sealed with the plug member 36. The water 80 flows from the reservoir 28 into the lower section 62 through the outlet 32 which results in the lower section 62 being filled with water 80. As the water 80 drains from the reservoir 28 air moves through the fluid passage 40 from the lower section 62 to the reservoir 28 in order to replace the water 80 moving out of the reservoir 28. When the water level 82 in the lower section 62 reaches the level of the second lower end 44 airflow through the fluid passage 40 is blocked. This results in a vacuum 84 being formed at the upper side 14 in the reservoir 28. Water flow through the outlet 32 terminates as soon as the force of the vacuum 84 can no longer be overcome by gravity.

By adjusting the height of the outlet 32, second lower end 44 and spacers 66 the water level 82 relatively to the platform 64 can be adjusted. Ideally the water level 82 is at the level of the platform 64. Water 80 moves through the apertures 68 by way of capillary action and is absorbed by the potting soil 78 and the roots 74. If the water lever 82 drops below the level of the second lower end 44 air again moves through the fluid passage 40 to fill the vacuum 84 which results in waterflow from the reservoir 28 through the outlet 32 and the rising of the water level 82. In this manner the plants 76 are continuously irrigated and allowed to grow in the unit 10.

As the water level of the water 80 inside the reservoir 28 drops the float 54 moves downwards along the tubular member 48 which provides a visual indication of when the water 80 in the reservoir 28 is depleted and needs to be replenished.

If water enters the cavity 26 as a result of external watering of the plants 76 or rain, or if the seal of the reservoir 28 is compromised, the water level 82 will rise above its ideal level and into the upper section 60. As soon as the water level 82 rises above the level of the overflow entrance 57 the water 80 flows from the upper section 60 through the overflow formation 56 out of the unit 10. This ensures that over watering of the plants 76 and the likelihood of the plants 76 being drowned are reduced.

If required the water 80 in the reservoir 28 can be drained by removing the drainage plug 71 from the outer wall 20. By adjusting the plug 71 the flow rate of the water 80 through the aperture 37 is regulated and if required the aperture 37 can be sealed by the valve seal 73. In this manner the plug 71 and valve seal 73 act as a valve means on the outlet 32.

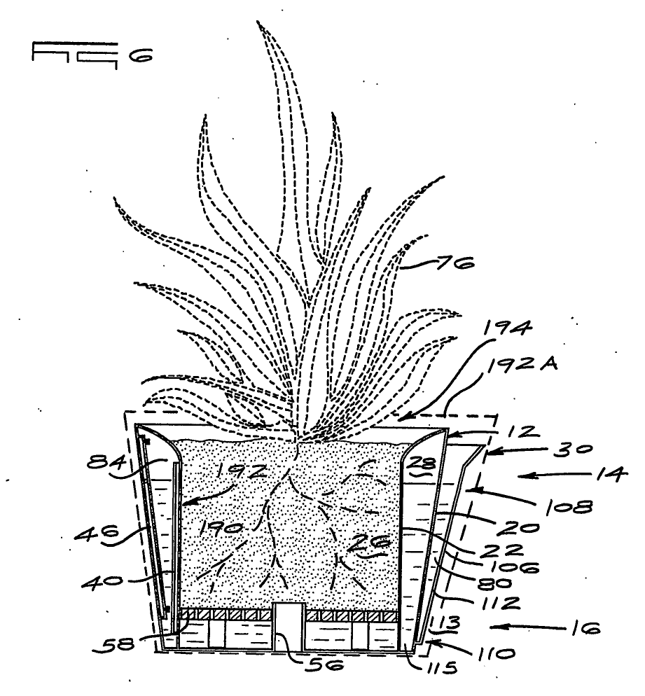

FIG. 5 shows a support formation 58A of an alternative construction to that of the support tray 58 and similar reference numerals to those used in respect of the support tray 58 are used to designate similar components in the support formation 58A and only the differences between the support tray 58 and the support formation 58A are described.

The support formation 58A has a circular wall formation 100 which extends from the platform 64 to define a receptacle or pot 102 wherein the potting soil 72 and plants 76 are located. As is the case with the support tray 58 the support formation 58A fits snugly into the cavity 26 to divide the cavity 26 into the upper section 60 (in this case the interior of the pot 102) and lower section 62. The advantage of the support formation 58A is that old plants 76 in the unit 10 can easily be replaced by merely removing an old support formation 58A and replacing same with fresh plants 76 in a new support formation 58A. The support formation 58A functions in exactly the same manner as the support tray 58 and the plants 76 in the support formation 58A are irrigated in exactly the same manner the plants 76 supported by the support tray 58.

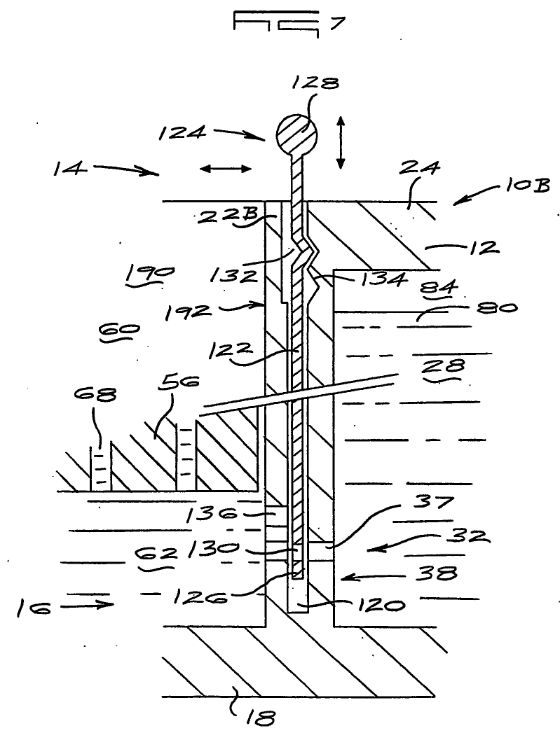

FIG. 6 shows an irrigation unit 10A according to another form of the invention. Again similar reference numerals to those used in respect of the unit 10 are used to designate similar components in the unit 10A and only the differences between the units 10 and 10A are described.

In the unit 10A the opening 34 and plug member 36 of the inlet 30 are replaced with an elongate liquid conduit 106 which extends from the upper side 14 to the lower side 16. At the upper side 14 the conduit 106 terminates in a funnel shaped upper entrance 108 and at the lower side 16 the conduit 106 terminates in an exit 110 into the reservoir 28. The conduit 106 is in the form of a duct 112 which extends on an outer side 113 of the outer wall 20. Alternatively the duct 112 can extend downwards on an inner side 115 of the outer wall 20.

The conduit 106 allows for the continuous refilling of the reservoir 28 as water entering the entrance 108 flows down the duct 112 and into the reservoir 28. The water 80 entering the reservoir 28 via the conduit 106 replaces the vacuum 84. Any excess air in the reservoir 28 is expelled from the reservoir 28 through the fluid passage 40.

It is important to note that the exit 110 is located below the level of the outlet 32 and the second lower end 44. This ensures that the functioning of the unit 10A and the creation of the vacuum 84 during use are not compromised.

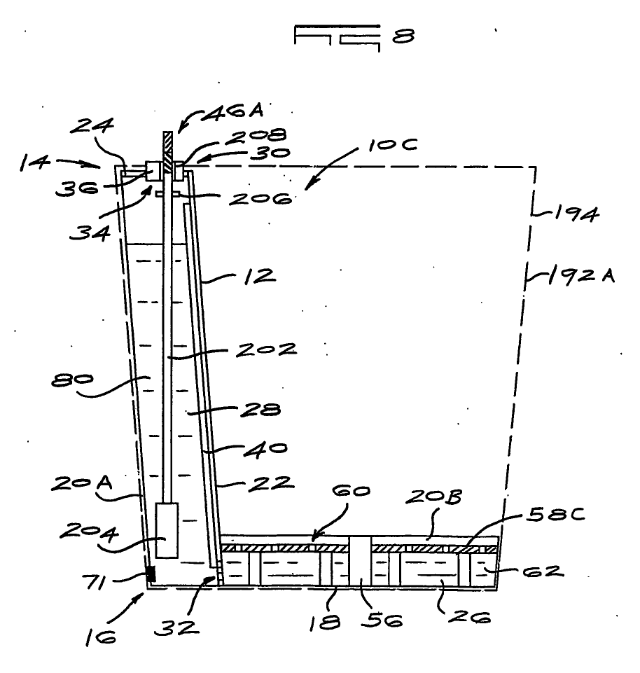

FIG. 7 shows an inner wall 22B of an irrigation unit 10B according to yet another form of the invention. Similar reference numerals to those used in respect of the units 10 and 10A are used to designate similar components in the unit 10B and only the differences between the units 10 and 10A and the unit 10B are described.

The unit 10B has an elongate, downwardly extending slot 120 in the inner wall 22B which cuts through the aperture 37. An elongate gate formation 122 fits snugly into the slot 120 and is movable relatively to the inner wall 22B. An upper extremity 124 of the gate 122 extends from the slot 120 at the upper side 14 and a lower extremity 126 of the gate 122 is located at the bottom of the slot 120 at the lower portion 38. An enlarged head 128 is formed at the upper extremity 124 and a channel 130 is formed in the gate 122 at the lower extremity 126. The channel 130 is of similar cross-sectional shape and size as the aperture 37.

A catch formation 132 in the form of a bend is formed in the gate 122. The catch 132 is complimentary shaped to at least one of the troughs of a W-shaped seat 134 formed in the slot 120. The catch 132 is resiliently engageable with either one of the troughs of the W-shaped seat 134.

The gate 122 is resiliently deformable to allow resilient movement of the catch 132.

An access opening 136 is formed in the inner wall 22B between the second section 62 and the slot 120 at a location which lies above the aperture 37.

In use the gate 122 acts as a sluice gate in order to allow a user (not shown) to open and close the aperture 37. In other words the combination of the slot 120, gate 122 and aperture 37 acts as a valve to stop flow of the water 80 in the reservoir 28 into the second section 62.

When the gate 122 is in the position shown in FIG. 7 the channel 130 is in alignment with the aperture 37 and the water 80 can flow from the reservoir 28 into the second section 62. In order to close the aperture 37 a user grips the gate 122 by the head 128 and moves the head 128 side ways and downwards so that the catch 132 moves along the seat 134. The gate 122 moves downwardly in the slot 120 so that the channel 130 is moved out of register with the aperture 37. In this position the gate 122 acts as a sluice gate to close the aperture 37 and the flow of water 80 through the aperture 37 is restricted. In order to open the aperture 37 the head 128 is again moved side ways and pulled upwards in order to move the catch 132 along the seat 134 and the gate 122 upwards in the slot 120. The channel 130 is brought into register with the aperture 37 to restore the flow of water 80 through the aperture 37.

The access opening 136 allows water 80 in the second section 62 to fill the slot 120. The water 80 in the slot 120 will however not rise above the level of the water 80 in the second section 62.

The valve arrangement shown in FIG. 7 is used in applications where the unit 10B has an inlet 30 of the kind shown in FIG. 1. Prior to the opening of the inlet 30 and the removal of the plug member 36 the aperture 37 is closed by way of the gate formation 122. This prevents any excess water 80 in the reservoir 28 from flowing into the cavity 26 when the inlet 30 is opened. Alternatively, and by forming a number of various sized channels 130 in the gate 122 and an equal number of thoughts on the seat 134 the valve arrangement shown in FIG. 7 can be used to adjust the flow rate of the water 80 through the aperture 37 in the units 10 and 10A.

In these examples a circular outer wall 20, inner wall 22, support tray 58 support formation 58A and overflow formation 56 are described. These components can have any other appropriate shape and can for example be square or oval shaped in plan. Additionally each of the outer wall 20, inner wall 22 and wall formation 100 can consist of a number of sections to make up each component.

The water 80 can also be replaced with any appropriate liquid to nourish and feed the plants 76. It is also envisaged that a plurality of overflow formations 56 can be used to drain excess water 80 from the second section 60.

The units 10, 10A and 10B act as self irrigating containers and in each of these examples the body 12 defines a plant container 190. Each plant container 190 is integrally formed with the body 12 and has a housing 192.

Alternatively the units 10, 10A, 10B can be used as an insert which is placed inside the housing 192A of a separate primary plant container 194 as is shown in dotted outlines in FIG. 6. The respective units 10, 10A, 10B can then be moved between various primary containers 194 as required without the need to replant the plants 76.

FIG. 8 shows an irrigation unit 10C which is formed separately from a primary container 194 which is shown in dotted outlines and with which the unit 10C is engaged by removably inserting the body 12 into the housing 192A.

Similar reference numerals to those used in respect of the units 10, 10A, 10B are used to designate similar components in the unit 10C and only the differences between the units 10, 10A, 10B and the unit 10C are described.

In the unit 10C the outer wall 22 has a first elongate portion 20A which extends from the base 18 to the upper side 14 and a second portion 20B which is shorter than the first portion 20A and which only extends partially between the base 18 and the upper side 14.

In this example the primary container 194 and body 12 are circular shaped in plan and the first portion 20A is C-shaped in plan. The inner wall 22 extends between the first portion 20A and the second portion 20B and in combination the second portion 20B and inner wall 22 are D-shaped in plan. The reservoir 28 is situated on one side of the body 12, does not extend around the cavity 26 and extends vertically away from the second portion 20B.

The support tray 58C is also D-shaped in plan and fits snugly between the second portion 20B and the inner wall 22.

The unit 10C has an alternative fluid level indicator 46A which is fitted to the plug member 36 and which extends at least partially into the reservoir 28.

The indicator 46A has an elongate rod 202 which extends through the plug member 36 and into the reservoir 28. A float 204 is attached to one end of the rod 202 which extends into the reservoir 28 and the opposite end of the rod 202 which extends from the plug member 36 is colour coded. A buffer 206 is attached to the rod 202 below and adjacent to the plug member 36. An o-ring seal 208 is fitted between the plug member 36 and the rod 202 to form an airtight seal between the plug member 36 and the rod 202.

In use the unit 10C is inserted into the primary container 194, the plug member 36 is removed and water 80 is poured into the reservoir 28 whereafter the plug member 36 is replaced to seal the reservoir 28. Plants 76 (not shown) and soil 78 (not shown) are placed in the primary container 194 and on top of the support tray 58C and the unit 10C is used to water the plants 76 in the manner described.

If the level of water 80 in the reservoir 28 is high the float 204 forces the rod 202 upwards in the direction of the plug member 36 until the , buffer 206 abuts against the plug member 36. The colour coded end of the rod 202 which extends from the plug member 36 provides a visual indication of the high level of water 80 in the reservoir 28. When the level of the water 80 in the reservoir 28 drops below the height of the float 204, the float 204 allows the rod 202 to move downwards into the reservoir 28 and the colour coded end of the rod 202 is drawn through the plug member 36. This provides a visual indication of the low level of water 80 in the reservoir 28 and that the water 80 in the reservoir 28 should be replenished.

Excess water 80 in the cavity 26 flows from the cavity 26 through the overflow 56 in the manner described. Appropriate drainage holes (not shown) in the primary container 194 allows the excess water 80 to flow from the primary container 194.

In an alternative form of the unit 10C the overflow 56 is removed and excess water 80 in the cavity 26 is allowed to spill over the second portion 20B which acts as a spillway or an alternative overflow formation. The excess water 80 then drains from the primary container 194 through the drainage holes therein.

The unit 10C can be retrofitted to a primary container 194 and the over watering of plants 76 planted in the primary container 194 is reduced by the withdrawal of excess water 80 from the primary container 200 through the overflow 56 or by the second portion 20B.

1-35. (canceled)

36. An irrigation unit which includes a body which has an upper side, a lower side, a base on the lower side, an outer wall which extends upwardly from the base and an inner wall which is engaged with and spaced from the outer wall, a cavity formed by the body, a reservoir defined between the inner and outer walls which has an inlet thereto and an outlet therefrom into the cavity, an open ended fluid passage which has an upper end which terminates in the reservoir and a second lower end which terminates in the cavity, an overflow formation which extends from the body and which is in communication with the cavity and a support formation in the cavity which has a platform and a plurality of spacers engaged with the platform with which the platform is spaced from the base, and wherein the overflow formation extends through the platform.

37. An irrigation unit according to claim 36 wherein the body includes a plant container.

38. An irrigation unit according to claim 37 wherein the plant container is integrally formed with the body.

39. An irrigation unit according to claim 36 wherein the inner wall extends between the outer wall and the base.

40. An irrigation unit according to claim 36 wherein the cavity is open ended towards the upper side.

41. An irrigation unit according to claim 36 wherein the inlet includes a plug opening in the body.

42. An irrigation unit according to claim 36 wherein the inlet includes an elongate liquid conduit which extends from an upper entrance to a lower exit into the reservoir.

43. An irrigation unit according to claim 36 wherein the outlet includes a valve means.

44. An irrigation unit according to claim 36 wherein the overflow formation is engaged with the base.

45. An irrigation unit according to claim 36 wherein the overflow formation is in the form of an upstanding, open ended, tubular member which extends through the body and from the base into the cavity.

46. An irrigation unit according to claim 45 wherein the overflow formation includes an overflow entrance which is spaced from the base and wherein the outlet and the lower end are located between the overflow entrance and the base.

47. An irrigation unit according to claim 36 wherein the overflow formation includes a spillway on the outer wall.

48. An irrigation unit according to claim 36 wherein the support formation divides the cavity into a lower section and an upper section wherein the outlet and the second lower end are in direct communication with the lower section and the overflow formation is in direct communication with the upper section.

49. An irrigation unit according to claim 36 wherein the platform includes a plurality of apertures and an enlarged hole there through.

50. An irrigation unit according to claim 36 wherein the support formation includes a wall formation extending from the platform to define a receptacle.

51. An irrigation unit according to claim 36 wherein the support formation is removably insertable into the cavity.

52. An irrigation unit according to claim 36 which includes a draining formation in the outer wall which is in communication with the reservoir.

53. An irrigation unit according to claim 36 which includes a liquid level indicator.

54. A plant container which includes a housing and an irrigation unit which is engaged with the housing and which has a body which has an upper side, a lower side, a base on the lower side, an outer wall which extends upwardly from the base and an inner wall which is engaged with and spaced from the outer wall, a cavity formed by the body, a reservoir defined between the inner and outer walls which has an inlet thereto and an outlet therefrom into the cavity, an open ended fluid passage which has an upper end which terminates in the reservoir and a second lower end which terminates in the cavity, an overflow formation which extends from the body and which is in communication with the cavity and a support formation in the cavity which has a platform and a plurality of spacers engaged with the platform with which the platform is spaced from the base, and wherein the overflow formation extends through the platform.

55. A method of growing a plant in a plant container which includes a housing and an irrigation unit which is engaged with the housing and which has a body which has an upper side, a lower side, a base on the lower side, an outer wall which extends upwardly from the base and an inner wall which is engaged with and spaced from the outer wall, a cavity formed by the body, a reservoir defined between the inner and outer walls which has an inlet thereto and an outlet therefrom into the cavity, an open ended fluid passage which has an upper end which terminates in the reservoir and a second lower end which terminates in the cavity, an overflow formation which extends from the body and which is in communication with the cavity and a support formation in the cavity which has a platform and a plurality of spacers engaged with the platform with which the platform is spaced from the base, and wherein the overflow formation extends through the platform which includes the step of planting the plant in the plant container.

56. A method of growing a plant according to claim 55 which includes the step of at least partially filling the reservoir with a liquid.
